(19) United States
(12) Patent Application Publication
(10) Pub. No.: US 2025/0153930 A1
(43) Pub. Date: May 15, 2025

(54) CONTAINER LIFT

(71) Applicant: Kevin D. Law, Williston, FL (US)

(72) Inventor: Kevin D. Law, Williston, FL (US)

(21) Appl. No.: 18/944,176

(22) Filed: Nov. 12, 2024

Related U.S. Application Data
(60) Provisional application No. 63/601,972, filed on Nov. 22, 2023.
(60) Provisional application No. 63/547,988, filed on Nov. 10, 2023.

(51) Int. Cl. B65F 1/14; B65F 1/10

(52) U.S. Cl. CPC B65F 1/1452; B65F 1/10

(57) ABSTRACT

A container lift apparatus for raising and depositing material into a dumpster. The apparatus has a lift frame to be secured to the side of the dumpster that also allows the apparatus to slide or roll on the side of the dumpster. A lift platform can dock at ground level receives material or objects thereon and is raised to an edge of the dumpster. A elevating mechanism and one or more levers tilt the lift platform, to slide the material off into the dumpster. The frame can adjust for different dumpster sizes. The upper end of the frame supports the apparatus on an edge of the dumpster and the bottom end can support the frame on the ground and can be raised to move the apparatus on the side of the dumpster.

### CROSS-REFERENCE TO RELATED APPLICATIONS

The present application claims priority to U.S. Provisional Application Ser. No. 63/601,972, filed Nov. 22, 2023; and U.S. Provisional Application Ser. No. 63/547,988, filed Nov. 10, 2023; which are hereby incorporated by reference herein in their entirety, including any figures, tables, or drawings.

### BACKGROUND OF INVENTION

Construction dumpsters are large, heavy containers with high sides. Materials are raised over the sides and deposited into the construction dumpster. Oftentimes material has to be manually deposited in the construction dumpster, which can be labor intensive. If the construction dumpster has a door, some materials can be pushed into the container, such as with a skid steer or tractor. However, this often does not allow the container to be completely filled, as material can fall out of the door and prohibit closing.

There is a need for an apparatus that can more easily be filled with material and more effectively be lifted and emptied over the side of a construction dumpster. It would be beneficial for the apparatus to be adjustable for different sizes or types of dumpsters and moveable along the side of the dumpster for more efficient use of dumpster space. It would be further beneficial if the apparatus were easily attachable and removable from a dumpster and be filled at ground level by sweeping or pushing material onto the apparatus.

### BRIEF SUMMARY

The present invention is directed to a container lift that satisfies the need to more easily and effectively deposit material into a construction dumpster. The apparatus comprises a lift platform supported on a lift frame that can be positioned on a side of the construction dumpster. The lift platform can receive material thereon and the frame system along with an elevating mechanism can raise the lift platform to the edge of the dumpster, where it can be tilted or dumped, so the material slides or falls out and into the construction dumpster. The lift platform can also support different types of containers for holding materials, which can be raised and tilted on the lift platform to dump materials into a construction dumpster. Advantageously, the lift platform can be lowered to ground level allowing material to be swept, pushed, or otherwise moved over the front edge and directly onto the lift platform.

Embodiments of the container lift have a lift frame that can be removably attached to and moved on the side of a construction dumpster. The lift frame can have frame members that have an upper end configured as a hook for engaging over an edge of a construction dumpster. The frame lift can also have one or more footers that cooperatively engage with the frame members to adjust the height of the lift frame for use with different construction dumpsters or other types of dumpsters. The footer can have a leg that cooperatively engages with the frame member, such as, for example, by a telescoping arrangement, and a platform at the lower end for contacting the ground or other surface that supports the lift frame. One or more braces can also be attached to and extend substantially horizontal to the lift frame for support against a side of the dumpster and to maintain the lift frame in a substantially vertical orientation. Between the frame members there can be one or more cross-supports that support the frame members in parallel during operation. In one embodiment, the lift frame is collapsible for more convenient transport. In another embodiment, the upper hook end of a frame member has one or more components that assist in moving the container lift along the edge of a construction dumpster, such as, for example, rollers, bearings, low-friction surfaces, or other motion-enabling features to facilitate sliding the lift frame on the edge of the dumpster.

In one embodiment, the lift platform has a seat that can be lowered or docked at ground level for receiving material over the front edge and that can support a secondary container. At the back of the seat, opposite to the front edge, can be an attached upright with a seat facing side and an opposite lift frame facing side. The lift platform can be lifted with an elevating mechanism that is operably connected to one or more levers attached to the lift platform.

On at least one side, ideally both sides, of the lift platform there can be arranged an elevating mechanism, such as, for example, a linear actuator, which can also be attached to the lift frame and one or more levers. Utilization of the elevating mechanism can raise the lift platform vertically and, alternatively, rails can be used to guide the lift platform until the lift platform reaches the edge of the construction container. As the linear actuator continues to apply force, the lift platform can tilt with the assistance of the one or more levers operably connected to the elevating mechanism, which cause the lift platform to tilt towards the construction dumpster until the seat is raised sufficiently, usually above the upright, to allow the material on the lift platform to be dumped into the dumpster. When the force of the linear actuator is released, the one or more levers allow the lift platform to reverse position until the upright is vertical again and the lift platform moves back down to ground level.

In a further embodiment of the subject invention, a lift platform of the subject invention can have a shape or form that is advantageous for receiving material and depositing the material into a construction dumpster, so that it moves away from the sides of the dumpster. The floor or seat of the lift platform can have a front edge that can advantageously receive material from ground level, such as, for example, by sweeping or pushing the material over the front edge and onto the seat. The lift platform can further have a chute formed by an upright or back wall opposite to the front edge that extends vertically for a distance and then transitions into a slide, where the back wall bows, curves, or bends inward to extend over a portion of the floor. When the lift platform is raised and tilted, material can slide from the seat to the chute and be directed towards the center of the construction dumpster for more effective use of the space therein. Each side of the lift platform can have one or more walls to at least partially enclose the seat and chute.

### BRIEF DESCRIPTION OF DRAWINGS

To provide a more precise understanding of the above recited invention, a more particular description of the invention briefly described above will be rendered by reference to specific embodiments that are illustrated in the accompanying drawings. The drawings presented herein may not be drawn to scale. Should dimension be provided or implied in the drawings or in the following description, such dimensions are specific to the embodiments disclosed. It will be understood that any variations of the dimensions that will allow the subject invention to function for its intended purpose are within the scope of the subject invention.

FIG. 1 illustrates a perspective view of one embodiment of the container lift of the subject invention arranged on one side of a generic dumpster. In this illustration the lift platform with a caddie seated thereon is shown in a downward or neutral position on or near ground level.

FIG. 2 is a side view of the container lift shown in FIG. 1, where the lift platform is at ground level or the neutral position.

FIG. 3 is a side view of the container lift shown in FIG. 2, with the lift platform at a topmost position on the lift frame.

FIG. 4 is a side view of the container lift shown in FIG. 3, with the seat of the lift platform pushed outward from the lift frame by a elevating mechanism. In the embodiment shown, the elevating mechanism is a linear actuator that is operably connected to a lever that supports the lift platform at or near the side of the seat.

FIG. 5 is a side view of the container lift shown in FIG. 4, where the elevating mechanism has forced the seat upwards and above the upright of the lift platform for dumping the material from a container attached thereto. In this Figure, the container shown on the lift frame is a caddie. The elevating mechanism has acted on the lever to force the floor of the caddie above the upright, so the material therein slides from the upright and is dumped at least some distance away from the edge of the construction dumpster.

FIG. 6 is a side view of the container lift, according to an alternative embodiment of the subject invention. In this embodiment, the elevating mechanism is operably connected directly to the upright of the lift frame, which acts as a lever for lifting the lift frame.

FIG. 7 is a side view of the container lift shown in FIG. 6, where the elevating mechanism, shown here as a linear actuator, has forced the upright outward from the lift frame until the seat is above the upright. This allows the material in a container attached to the lift frame to be dumped into the dumpster. The container shown is a caddie and the floor of the caddie has been raised above the chute.

FIG. 8 is a photograph of a container lift, according to an embodiment of the subject invention, arranged on a side of a construction dumpster. The container lift is shown in a down or neutral position at or near ground level.

FIG. 9 is a photograph of the container lift in FIG. 8, in a partially raised position.

FIG. 10 is a photograph of the container in FIG. 8, in a fully raised position over the side edge of a construction dumpster. The material in the lift platform can be seen sliding over the upright and away from the edge of the construction dumpster.

### DETAILED DESCRIPTION

The subject invention pertains to an apparatus that can be attached to a construction dumpster (herein referred to as a “dumpster”) for depositing materials therein. More specifically, the subject invention provides one or more embodiment of a container lift capable of raising a container to an edge of a dumpster and tilting the container to deposit, release, or otherwise dump material in the container into the dumpster.

For the sake of literary convenience, embodiments of the subject invention will be described and shown in the Figures herein with respect a construction dumpster. Therefore, while the following description is with respect to depositing materials into a construction dumpster, such as those typically utilized in construction sites, embodiments of the invention are not limited to such use. A person with skill in the art will be able to recognize numerous other uses and types of dumpster that would be applicable to the devices and methods of the subject invention.

As used herein, and unless otherwise specifically stated, the terms “operable communication,” “operable connection,” “operably connected,” “cooperatively engaged” and grammatical variations thereof mean that the particular elements are connected in such a way that they cooperate to achieve their intended function or functions. The “connection” or “engagement” may be direct, or indirect, physical or remote.

As used herein, the term “substantially” refers to the complete or nearly complete extent or degree of an action, characteristic, property, state, structure, item, or result. For example, an object that is “substantially” in a given position including but not limited to vertical, horizontal, or adjacent to or aligned with another object, would mean that the object is either completely in that position or nearly completely in that position. The exact allowable degree of deviation from absolute completeness may in some cases depend on the specific context. However, generally speaking the nearness of completion will be so as to have the same overall result as if absolute and total completion were obtained.

Also used herein, terms indicating relative direction or orientation, including but not limited to “upper”, “lower”, “top”, “bottom”, “vertical”, “horizontal”, “outer”, “inner”, “front”, “back”, “left”, “right” and the like, are intended to facilitate description of the present invention by indicating relative orientation or direction in usual use, and are not intended to limit the scope of the present invention in any way to such orientations or directions.

Furthermore, the description herein of any aspect or embodiment of the invention using terms such as “comprising,” “having,” “including,” or “containing” with reference to an element or elements is intended to provide support for a similar aspect or embodiment of the invention that “consists of,” “consists essentially of,” or “substantially comprises” that particular element or elements, unless otherwise stated or clearly contradicted by context (e.g., a composition described herein as comprising a particular element should be understood as also describing a composition consisting, or consisting essentially, of that element, unless otherwise stated or clearly contradicted by context). Use of the term “comprising” contemplates other embodiments that “consist” or “consist essentially of” the recited component(s).

Reference will be made to the attached Figures on which the same reference numerals are used throughout to indicate the same or similar components. With reference to the attached Figures, which show certain embodiments of the subject invention, it can be seen that a container lift 50 of the subject invention comprises a lift frame 100 with frame members 110 that are shaped to engage with the edge 12 on a sidewall 14 of a construction dumpster 10, in particular, hook ends go over an edge 12 of a construction dumpster. The frame members can have rails 120 thereon that are operably connected to a lift platform 130 by one or more lock levers 150. In further embodiments, an elevating mechanism 200 is directly or indirectly cooperatively engaged with the lift platform. The elevating mechanism can be activated to raise the lift platform vertically, optionally on the rails, to a stop 122, at which point the lift platform is tilted outward from the frame members and inverted, whereby material is deposited or “dumped” over the edge of and into the construction dumpster. Each of these general components can have one or more sub-components, which will be discussed in detail below.

It is to be understood that the figures and descriptions of embodiments of the present invention have been simplified to illustrate elements that are relevant for a clear understanding of the invention, while eliminating, for purposes of clarity, other elements that may be well known. Those of ordinary skill in the art will recognize that other elements may be desirable and/or required in order to implement the present invention.

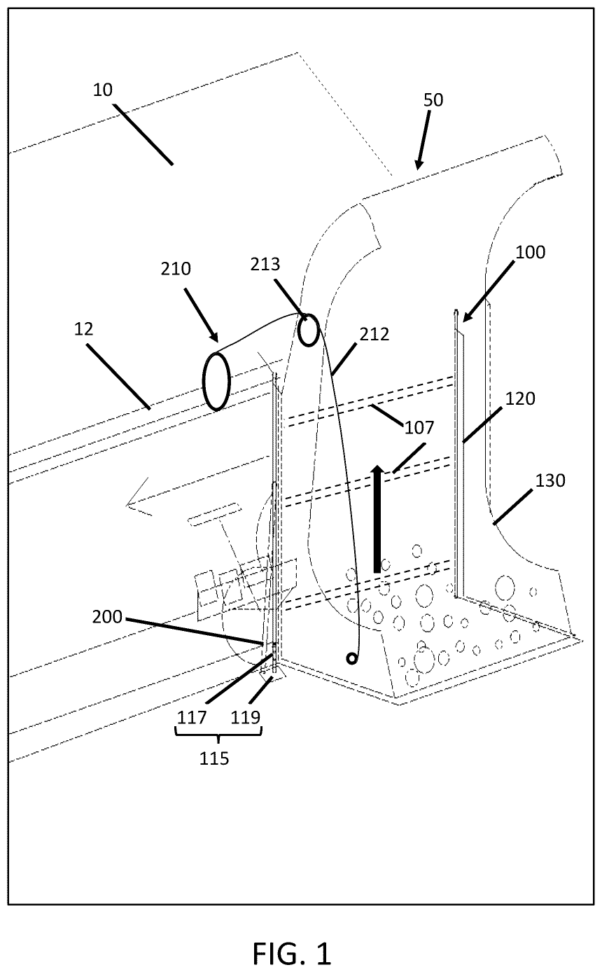

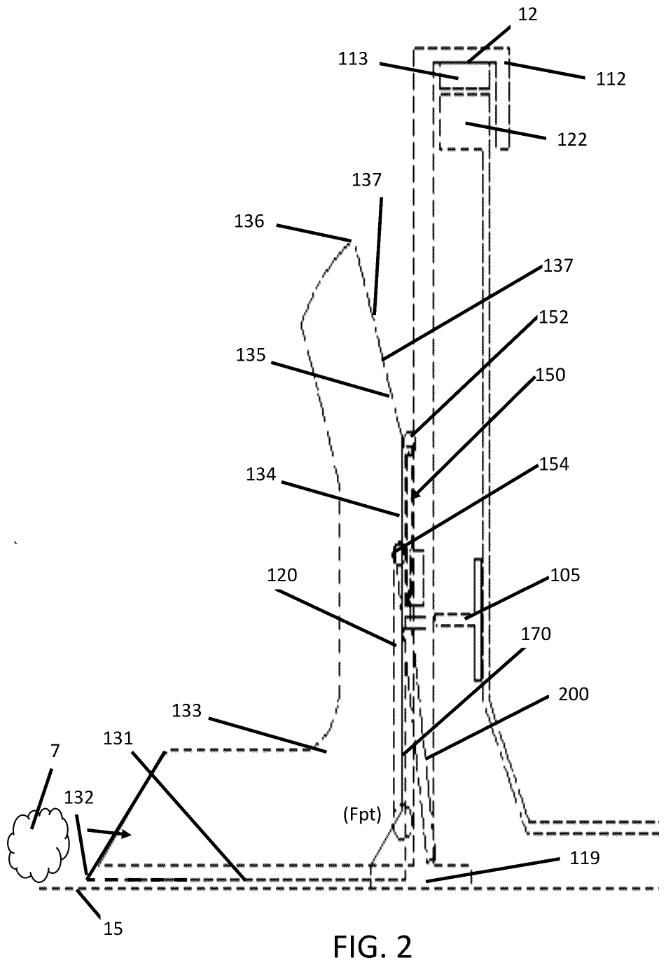

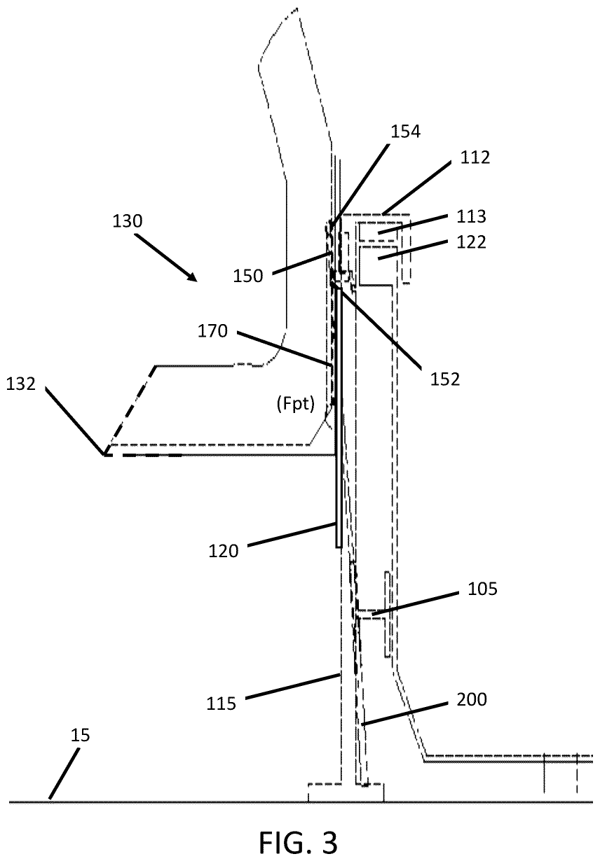

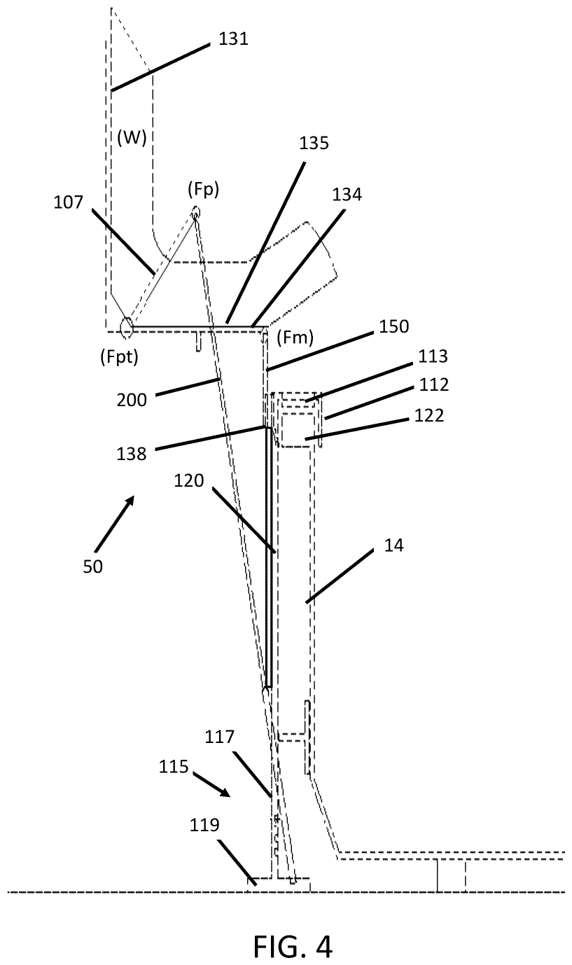

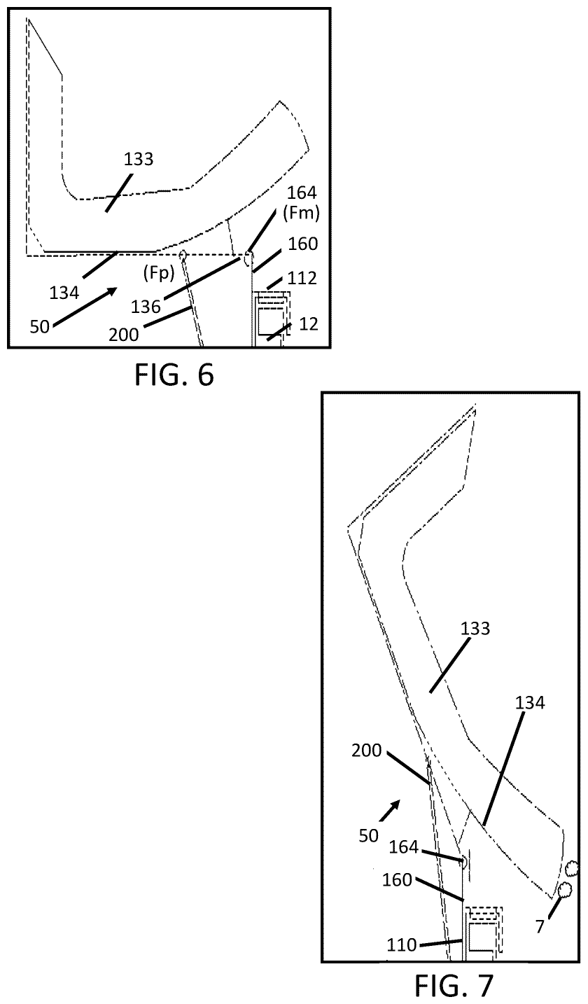

In one embodiment, the container lift 50 has a lift frame 100 for raising and lowering a lift platform 130. The lift frame can have one or more frame members 110 arranged vertically side-by-side. Ideally, the lift frame has paired frame members. The frame members can have hook ends 112 that engage over an edge 12 of the construction dumpster 10, an example of which is shown in FIGS. 2 and 6. There can be one or more braces 105 attached to one or more of the frame members for stabilizing the frame member against a wall of the construction dumpster, as shown in FIGS. 3 and 4, by way of example. Additionally, one or more cross-supports 107 can be arranged between multiple frame members for maintaining the frame members at a pre-determined distanced and parallel to one another, as shown, for example, in FIG. 1.

It can be advantageous for the height of the lift frame 100 to be adjustable. In one embodiment, a frame member has a footer 115 arranged at the bottom end. This can be beneficial for stabilizing the container lift on an uneven surface. In one embodiment, the footer has a leg 117 that cooperatively engages with a frame member and the leg can have a platform at the most distal end that sits on the ground to support the lift frame 100.

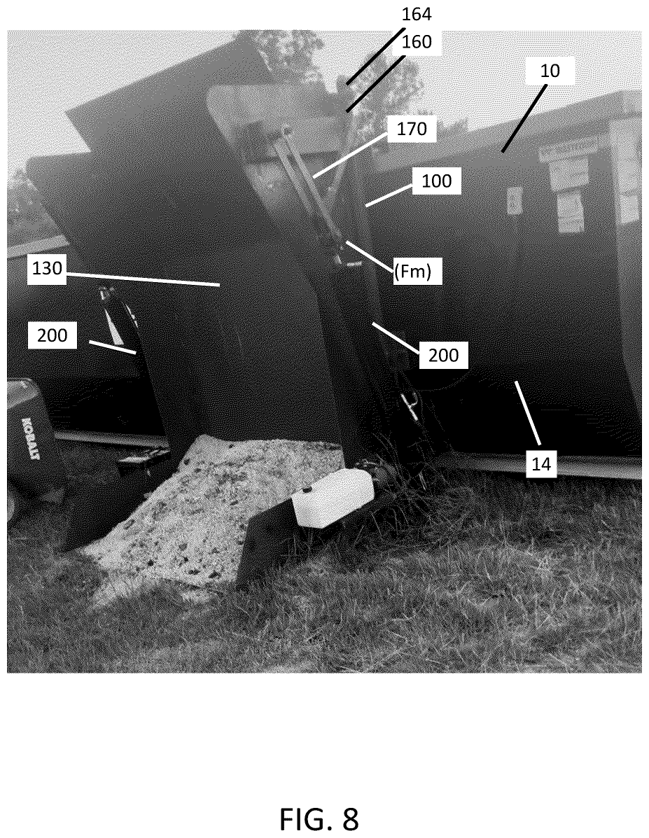

In one embodiment, a lift platform 130 is operatively connected to the lift frame 100. A lift platform can be utilized to contain the material to be dumped into the construction dumpster. A lift platform can have a substantially flat seat 131 arranged horizontally and, ideally, can be docked close to or at ground level. This allows material on the ground to be pushed, blown, or otherwise directed onto the platform over a front edge 132, which is shown, by way of example, in FIGS. 2 and 8. The seat can transition upwards at the backside to an upright 134 that can function as a chute 186 for directing material into a construction dumpster, as described in more detail below.

The purpose of the lift platform 130 is to carry material upward to be deposited or dumped into the construction dumpster. Ideally, the lift platform is raised from ground level to a tilted or inverted position above the side edge 12 of the construction dumpster 10. A person of skill in the art would be able to select an appropriate elevating mechanism 200 for raising, lowering, and/or otherwise controlling movement of the lift platform from any of a variety of devices known in the art and suitable for the intended purpose. Such elevating mechanisms can be powered hydraulically, pneumatically, electrotonically, manually, or any combination thereof. That being said, it can be preferable for a container lift 100 to be self-contained and require minimal assembly on site. Further, as mentioned above, embodiments of a lift platform can also be moved on the edge 12 along the sidewall 14 of a construction dumpster 10 and to other dumpsters. Thus, it would be beneficial for the container lift to be movable as a self-contained unit. Therefore, the elevating mechanism selected for raising the lift platform can, ideally, be fully or at least partially incorporated with the container lift.

In one embodiment, the elevating mechanism comprises a motorized linkage 210, which can include one or more motors 211 with drive shafts, gears, cams, wheels, other rotating mechanisms, and combinations thereof. The motor can operate on a flexible linkage 212, such as, for example, rope, wire, cable, chain, or the like, to apply a force to raise the lift platform. Further, a redirect device 213, such as, for example, a gear, spool, pulley, block, tackle, or other devices and combinations thereof can be utilized to direct the force and create the tilt or inversion of the tilt platform. FIG. 1 illustrates a non-limiting example of a motorized linkage 210.

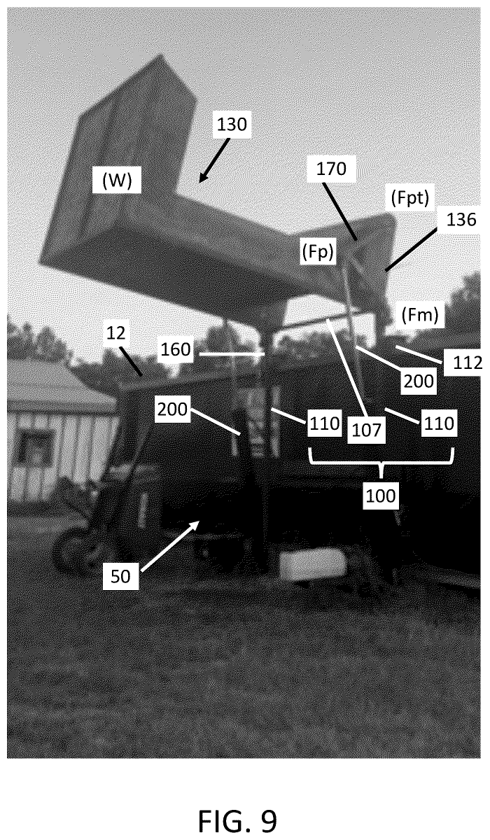

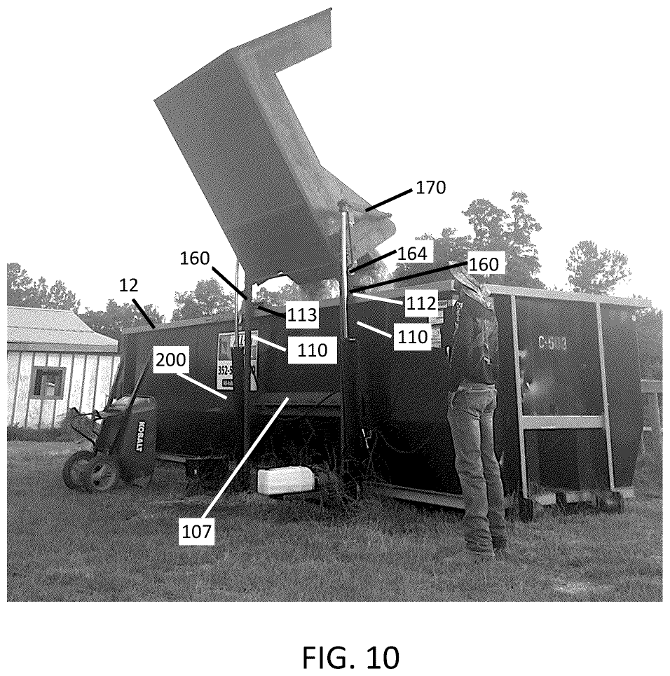

In another embodiment, the elevating mechanism 200 comprises one or more linear actuators 200. A linear actuator can be any device capable of providing linear motion. In one embodiment, the linear actuator is a motorized rotary screw. In another embodiment, the linear actuator is a hydraulic or pneumatic piston. The linear actuator can be arranged between the lift frame and the lift platform to apply a linear force against a specific point on the lift platform. Likewise, the components that operate the linear actuator can be arranged on the container lift. FIGS. 3, 4, 8, 9, and 10 illustrate a non-limiting example of a hydraulic piston supported on a lift frame and operably connected to the lift platform.

The frame members 110 can be arranged at or near a side of the lift platform. More specifically, when the lift platform is docked in a neutral or fully down position, preferably at ground level, the frame members can be arranged at or near the upright 134. In one embodiment, an example of which is shown in FIGS. 2, 3, and 4, the frame members of the lift frame 100 are behind the upright, so as to be between the upright and the side of a construction dumpster. In an alternative embodiment, the frame members can be to either side of the upright, such as shown, for example, in FIGS. 2 and 8.

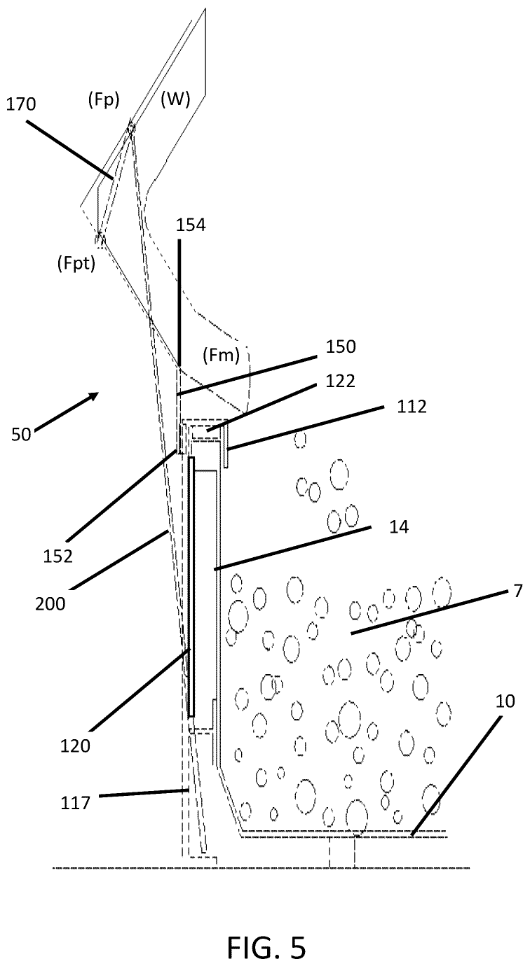

In a further embodiment, the frame members can have rails 120 affixed thereto that are utilized to guide the lift platform as it moves upward. A lock lever 150 can be utilized to operably connect the upright 134 of the lift platform to a rail on a frame member. In one embodiment, a lock lever has a slide end 152 that is slidably connected to the rail, for example, with a slide hinge. The opposite end of the lock lever can have a pivot end 154 that is rotatably or pivotally coupled to the upright 134, such as, for example, at or near an upright upper edge 136. When the lift platform is raised by the elevating mechanism 200, the lock lever is between the upright and the rail. The slide end can slide, roll, or otherwise move on the rail, as shown, for example, in FIG. 3, as it advances upward on the rail. A rail stop 122 at or near the upper end of the rail can inhibit advancement of the lock lever, such that the pivot end is at or near the upper end of a frame member. A rail stop can be a blocking piece, a crimped rail end, combinations thereof, or other devices known in the art. In one embodiment, the stop position on the rail allows the lock lever to extend above the upper end of the frame member, as shown, for example, in FIG. 4. This allows the pivot end 154 and the upper edge 136 of the upright to extend above the hook end of the frame member, an example, of which is shown in FIGS. 3, 4, and 5. As the elevating mechanism 200 continues to apply force, the pivot end 154 can act as fulcrum, which causes the lift platform to “fold” out, rise up, swing, or otherwise rotate on the pivot end away from the lift frame 100. The elevating mechanism can continue applying force to tilt the lift platform until the lift platform is inverted, with the seat 131 above the upright, as shown, for example, in FIGS. 5 and 7. This allows material in the seat to transfer to and slide off the seat facing side 135 of the lift platform. Reversal of the elevating mechanism 200 allows the lift platform to move downward and towards the frame members, with the lock lever therebetween to slide downward in the rail to dock the lift platform again at ground level.

In an alternative embodiment, a frame member can comprise a vertical extension 160. The vertical extension can have a fulcrum end 164, similar to the pivot end 154 of a lock lever 150. In one embodiment, the vertical extension positions the fulcrum end near or above the hook end 112 of the frame member, for example, as shown in FIGS. 6 and 7. With this embodiment, the upper end 136 of the upright 134 of the lift platform 130 can be rotatably coupled, such as, for example, with a hinge, pin, or any similar device, to the fulcrum end (Fm) of the vertical extension. The elevating mechanism can also be rotatably coupled to the upright at a first point (Fp) between the seat and the upper end, an example of which is also shown in FIGS. 6 and 7. This configuration utilizes the upright 134 as a Class 3 lever. The elevating mechanism can exert against the first point (Fp) on the upright, which can swing or rotate the lift platform on the fulcrum end 164 to move the seat 131 out and away from the lift frame 100 until the lift platform is inverted, with the seat above the upright, as shown, for example, in FIG. 7. In this inverted position the fulcrum end (Fm) can be below the first point (Fp) where the elevating mechanism contacts the upright. As before, this allows material on the seat to transfer to and slide off the upright 134, which is shown, for example, in FIG. 7. FIGS. 8, 9, and 10 show another embodiment comprising a piston as the elevating mechanism. In this embodiment, one end of the piston is attached to a first point (Fp) located on a sidewall 133 on each side of the lift platform, between the upper end 136 and the seat 131. The upper end of the upright 134 is rotatably attached to the fulcrum end 164 of the vertical extension 160. Force applied by the piston can lift or rotate the seat 131 away from the lift frame 100 to an inverted position with the seat above the upright and the upper end over the edge of the dumpster.

The utilization of levers can be beneficial in lifting and tilting or inverting the lift platform with an elevating mechanism. As mentioned above, the embodiments shown in FIGS. 6 through 10 illustrate Class 3 levers. The embodiment shown in FIGS. 6 and 7 illustrate a simple Class 3 lever comprising the fulcrum end 164, a weight (W) represented by the lift platform, and a point for first point (Fp) therebetween, where a force is applied by the elevating mechanism. The embodiment shown in FIGS. 8, 9, and 10 illustrates a compound lever system where Class 3 levers are combined to maximize the effort applied to the first point (Fp) to not only raise, but also tilt or invert the lift platform. In this embodiment the elevating mechanism exerts force against a first point (Fp) located between the weight (W) of the lift platform and the upper end, which is rotatably attached to a the fulcrum end (Fm) on a vertical extension 160. This comprises a Class 3 lever. In a further embodiment a transfer lever 170 is incorporated between the fulcrum end and the first point. FIGS. 8, 9, and 10 shown an example of a transfer lever as a rigid V-shaped structure, which operates as a Class 3 lever by transferring or redirecting a portion of the force from the elevating mechanism to a second point (Fpt) on the sidewall 133 of the lift platform. This embodiment allows a single piston on each side of the lift platform control both raising and tilting or inverting of the lift platform.

FIGS. 1-5 illustrate an embodiment that also utilizes a compound lever system that incorporates Class 3 levers. The first Class 3 lever comprises the pivot end 154 of the lock lever 150 where the upright attaches, which acts as the fulcrum (Fm), the weight of the lift platform (W), and the point of force (Fp) from the piston exerted therebetween. The second Class 3 lever comprises the same fulcrum (Fp) and weight (W), but a transfer lever 170 transfers or distributes force from the elevating mechanism to second point of force (Fpt) on the lift platform. The second point (Fpt) is closer to the seat end and can facilitate tilting or inverting of the lift platform for dumping material thereon into the dumpster, as shown in FIG. 5.

All patents, patent applications, provisional applications, and other publications referred to or cited herein are incorporated by reference in their entirety, including all figures and tables, to the extent they are not inconsistent with the explicit teachings of this specification. Additionally, the entire contents of the references cited within the references cited herein are also entirely incorporated by reference.

1. A container lift, configured to be supported on a dumpster, comprising:
a lift frame comprising:
a frame member having a hook end, configured to support the lift frame on an edge of the dumpster,
a fulcrum end at or near the hook end, and
a footer cooperatively engaged with the frame member, configured to support the lift frame on a supporting surface;
a lift platform comprising:
a seat having a front edge, configured to be docked at ground level, and
an upright opposite to the front edge and that extends upward to an upper end and rotatably couples with the fulcrum end; and
an elevating mechanism, cooperatively engaged with the lift platform, wherein the elevating mechanism is configured to exert a linear force on a first point (Fp) on the lift platform that rotates the lift platform on the fulcrum end to raise the seat above the upright and position the upper end over a sidewall of the dumpster.

2. The container lift according to claim 1, further comprising a slide component on the hook end that is configured to facilitate sliding the lift frame on the edge of the dumpster.

3. The container lift according to claim 1, wherein the lift platform comprises a sidewall.

4. The container lift according to claim 1, wherein the elevating mechanism is a linear actuator.

5. The container lift according to claim 4, wherein the linear actuator is a piston operably connected to a first point (Fp) on the lift platform.

6. The container lift according to claim 5, further comprising a transfer lever rotatably connected to the first point (Fp) and to a second point (Fpt) on the lift platform, such that, when the piston exerts a linear force on the lift platform, the transfer lever redirects a portion of the linear force to the second point.

7. The container lift according to claim 6, wherein the second point (Fpt) is at or near the seat of the lift platform, such that the redirected linear force rotates the seat above the upright.

8. The container lift according to claim 6, wherein the second point (Fpt) is at or near the upper end of the upright, such that the redirected linear force rotates the upper end to bring the seat above the upright.

9. A container lift, configured to be supported on a dumpster, comprising:
a lift frame comprising:
a frame member having a hook end, configured to support the lift frame on an edge of the dumpster,
a rail arranged on the frame member and including a rail stop, and
a footer cooperatively engaged with the frame member, configured to support the lift frame on a supporting surface;
a lift platform comprising:
a seat having a front edge, configured to be docked at ground level, and
an upright opposite to the front edge and that extends upward to an upper end;
a lock lever comprising:
a slide end that slides on the rail, and
a pivot end on which the upright rotates, such that the lock lever is between the rail on the frame member and the upright of the lift platform;
a transfer lever comprising:
a first point (Fp),
a second point (Fpt), wherein the second point is rotatably connected at or near the seat of the lift platform; and
an elevating mechanism, rotatably coupled to the first point (Fp).

10. The container lift according to claim 9, further comprising a slide component on the hook end that is configured to facilitate sliding the lift frame on the edge of the dumpster.

11. The container lift according to claim 9, wherein the lift platform comprises a sidewall and the second point (Fpt) is rotatably connected to the sidewall.

12. The container lift according to claim 9, wherein the elevating mechanism is a linear actuator.

13. The container lift according to claim 12, wherein the linear actuator is a piston operably connected to the first point (Fp) on the lift platform.

14. The container lift according to claim 9, wherein the rail stop is positioned on the rail to inhibit sliding of the lock lever after the pivot end extends above the hook end of the frame member.

15. A method for depositing material into a dumpster, the method comprising:
obtaining a container lift, according to claim 1; and
activating the elevating mechanism to exert a linear force against the first point (Fp), whereby the lift platform rotates on the fulcrum end to raise the seat above the upright, such that material on the container lift slides off the upright and into the dumpster.

16. The method according to claim 15, wherein the frame member further comprises a slide component on the hook end, and the method further comprises sliding the lift frame on an edge of the dumpster.

17. The method according to claim 15, wherein the lift platform is raised from a ground level.

18. A method for depositing material into a dumpster, the method comprising:
obtaining a container lift, according to claim 9; and
activating the elevating mechanism to:
exert a linear force against the first point (Fp) on the transfer lever so the slide end of lock lever slides in the rail to raise the lift platform until inhibited by the rail stop and the pivot end is above the hook end of the frame member, and
rotate the lift platform on the pivot end until the second point (Fpt) directs force to tilt the seat above the upright of the lift platform.

19. The method according to claim 18, wherein the frame member further comprises a slide component on the hook end, and the method further comprises sliding the lift frame on an edge of the dumpster.

20. The method according to claim 18, wherein the lift platform is raised from a ground level.
